(19) United States
(12) Patent Application Publication
(10) Pub. No.: US 2026/0048891 A1
(43) Pub. Date: Feb. 19, 2026

(54) WEBBED-CORNERED SELF-ERECTING TRAY

(71) Applicant: Southern Champion Tray, LLC, Chattanooga, TN (US)

(72) Inventors: William Harvey Jones, Chattanooga, TN (US); Mark Steven Smith, Chattanooga, TN (US); David Joseph Chapman, Chattanooga, TN (US)

(73) Assignee: Southern Champion Tray, LLC, Chattanooga, TN (US)

(21) Appl. No.: 19/300,054

(22) Filed: Aug. 14, 2025

Related U.S. Application Data
(60) Provisional application No. 63/683,306, filed on Aug. 15, 2024.

(51) Int. Cl. B65D 5/36; B31B 50/26; B31B 50/73; B31B 100/00; B31B 120/30

(52) U.S. Cl. CPC B65D 5/3657; B31B 50/26; B31B 50/73; B31B 2100/00; B31B 2120/302

(57) ABSTRACT

A web-cornered self-erecting food tray assembled from a blank with folded and adhered elements. The assembled tray includes webbed corners with fixed and movable panels that fold and are engaged automatically which enables the tray to transition from an assembled collapsed configuration to an assembled expanded configuration without disassembly.

### CROSS-REFERENCE TO RELATED APPLICATIONS

The present application claims the benefit of U.S. Provisional patent application Ser. No. 63/683,306, filed Aug. 15, 2024, entitled WEBBED-CORNERED SELF-ERECTING TRAY which is incorporated by reference herein in its entirety.

### BACKGROUND

Presently, many diners, bars, restaurants, and locations like stadiums that provide concessions serving food utilize a foldable food tray. These food trays are capable of holding and transporting food from one location to the next (e.g., from the counter to the customer's table). Manufacturing, assembly, and storage of a food tray are significant factors in its value and convenience. Many of the food trays available only have two configurations. One configuration is unassembled and collapsed, where the food tray is a flat but creased blank that is incapable of holding food items but is suitable for storage and transport of bulk trays. For a business, purchasing trays in this configuration allows for more trays to be ordered and shipped at one time since they take up less space. However, when the trays are in use a substantial amount of time is lost due to the need to assemble the trays and to make the trays suitable for holding food items. This issue is made worse by the fact that trays of this type are often used in fast paced environments that have limited personnel. In other cases, a business may order trays in the assembled and expanded configuration. On one hand, this configuration saves time because the tray is ready to be used immediately. However, assembled and expanded trays take up more valuable storage space since they are bulkier and don't lay flat. This means a business will have to order and can store fewer units.

What is needed is a food tray that is more easily reconfigured from a collapsed configuration that is suitable for transport and an expanded configuration suitable for holding food.

### SUMMARY OF THE INVENTION

Embodiments of the present invention address these and other needs by having an assembled collapsed configuration and an assembled expanded configuration. Certain implementations of the web-cornered self-erecting food tray consist of a perforated or creased blank. The blank is composed of a base panel having a pair of first opposing sides and a pair of second opposing sides. Attached to the first opposing sides are a pair of width panels, each having an inner surface, an outer surface, a first free edge, a first connected edge, and a pair of opposing ends, wherein a separate one of each of the pair of width panels is joined continuously at the connected edge to one of the first opposing sides of the base panel along a width joint that extends continuously along an entire width of the width panel. Attached to the second opposing sides of the base panel are a pair of length panels, each having an inner surface, an outer surface, a second connected edge, a third connected edge, and a pair of opposing ends. A separate one of each of the pair of length panels is joined continuously at the second connected edge to one of the second opposing sides of the base along a length joint that extends continuously along an entire length of the length panel. Attached to each length panel is a lock panel joined continuously along a third connected edge. Each lock panel has an inner surface, an outer surface, a second free edge, and a pair of opposing ends, wherein the lock panel is configured to be folded along the third connected edge and a center of the inner surface of the lock panel is configured to be fixedly attached, preferably with an adhesive, to a center of the inner surface of the length panel. The pair of opposing ends of the lock panels are not attached to the length panel and are configured to flare outwards from the length panel to provide flared ends. A length measured between the opposing ends of the lock panel is less than the length measured between the opposing ends of the length panels such that a separate engagement space is provided adjacent the inner surface of the length panel and adjacent each opposing end of the lock panel,

Positioned between each adjacent width and length panel is a webbed corner. Each webbed corner is formed by a fixed panel hingedly joined to the width panel along a first corner joint and fixedly attached, preferably with an adhesive, to the outer surface of the width panel; and a movable panel hingedly joined to the length panel along a second corner joint, wherein the fixed panel and movable panel are joined together along a third corner joint.

When the tray is in the assembled collapsed configuration the inner surfaces of the width and length panels and the outer surface of the lock panels are not held substantially perpendicularly to an inner surface of the base panel. Furthermore, the inner surfaces of the width panels are not oriented substantially perpendicularly to the inner surfaces of length panels and the outer surfaces of the lock panels; the width panels are not prevented from folding inwards towards the base panel about the width joint by the lock panel; and the fixed and movable panels of the webbed corners are not oriented perpendicularly to the inner surface of the length panels.

When the tray is in the assembled expanded configuration the inner surfaces of the width and length panels and the outer surface of the lock panels are held substantially perpendicularly to the inner surface of the base panel. Additionally, the inner surfaces of the width panels are oriented substantially perpendicularly to the inner surfaces of length panels and the outer surfaces of the lock panels; and the fixed and movable panels of the webbed corners are oriented perpendicularly to the inner surface of the length panels. Also, each of the opposing ends of each width panel is configured to contact one of the flared ends of one of said lock panels and, through such contact, is prevented from folding inwards towards the base panel about the width joint; and the opposing ends of the width panels are each located in one of the engagement spaces when contacting the flared ends of the lock panel.

The present invention also provides a method for assembling the web-cornered self-erecting food tray into the assembled collapsed configuration. Preferably, in this order, each lock panel is first folded inwards towards the base panel along the third connected edge. Then a center of the inner surface of each lock panel is fixedly attached, preferably using an adhesive, to a center of the inner surface of the length panel to form a combined lock and length panel where the pair of opposing ends of each lock panel are not attached to the length panel and are configured to automatically flare outwards from the length panel to provide flared ends.

Next, each width panel is folded inwards towards the base panel along the first connected edge causing the movable panels to automatically fold inwards along the second corner joint as the width panels are folded inwards towards the base panel along the first connected edge. Then each length panel is folded inwards towards the base panel along the second connected edge causing the fixed panels to automatically fold inwards along the first corner joint as the length panels are folded inwards towards the base panel along the second connected edge. The fixed panel of each webbed corner is then fixedly attached, preferably via an adhesive, to the outer surface of one of the width panels.

When moving from the assembled collapsed configuration to the assembled expanded configuration, each width panel is folded outwards away from the base panel along the first connected edge causing each combined lock and length panel to automatically fold outwards away from the base panel along the second connected edge. The opposing ends of the width panels are automatically positioned in the engagement space and contact the flared ends of the lock panels as the width panels are folded outwards from the base panel. Through such contact, the width panels are prevented from folding inwards towards the base panel about the first connected edge and are held substantially perpendicularly to the inner surface of the base panel.

### BRIEF DESCRIPTION OF DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 depicts an unassembled blank usable for forming a webbed-cornered self-erecting food tray according to an embodiment of the present invention;

FIGS. 2A-2D are top perspective views depicting a process for forming an unassembled blank of FIG. 1 into a webbed-cornered self-erecting food tray in an assembled collapsed configuration.

FIG. 3A is a top perspective view depicting the webbed-cornered self-erecting food tray of FIG. 2 in an assembled expanded configuration.

FIG. 3B is a top perspective view depicting a corner of the webbed-cornered self-erecting food tray of FIG. 3A, where a width panel sits in an engagement space and rests against a flared end of a lock panel.

FIGS. 4A-4D is a top perspective view illustrating a process for reconfiguring the webbed-cornered self-erecting food tray of FIG. 2 into the webbed-cornered self-erecting food tray of FIG. 3A.

### DETAILED DESCRIPTION OF THE INVENTION

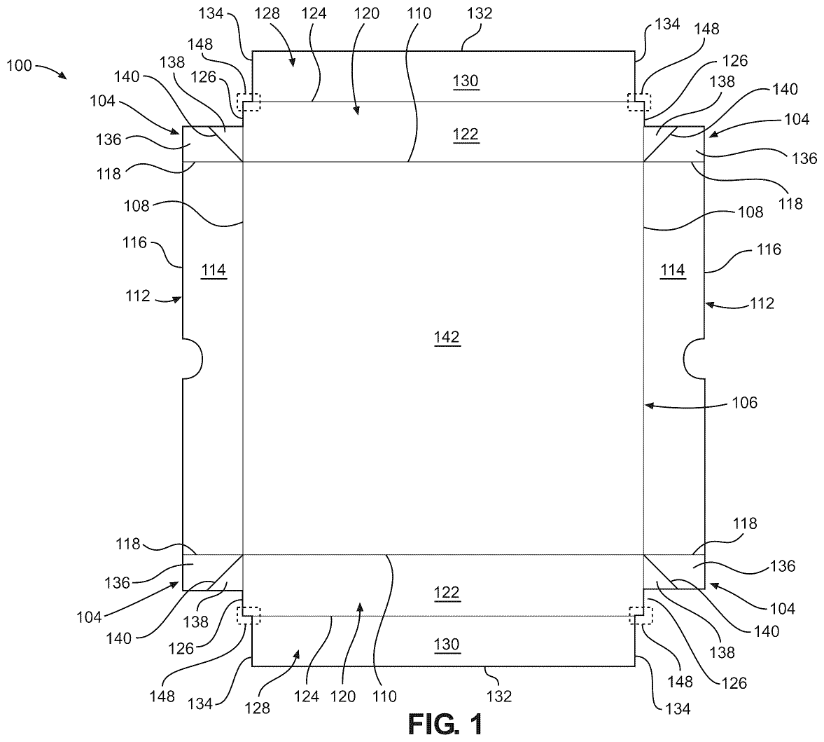

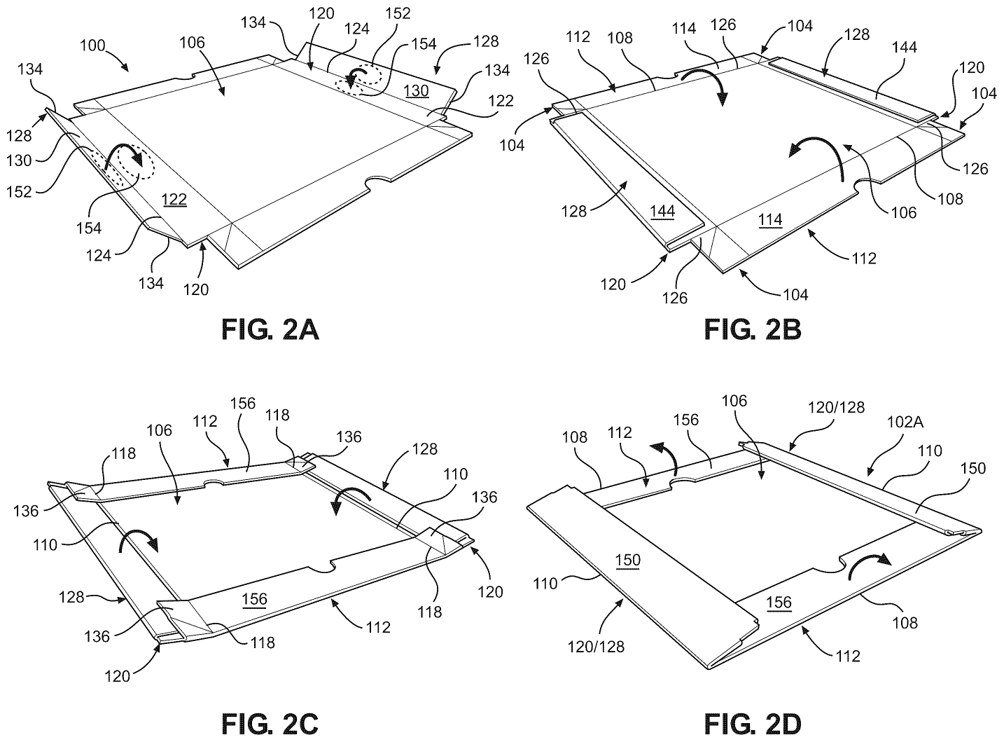

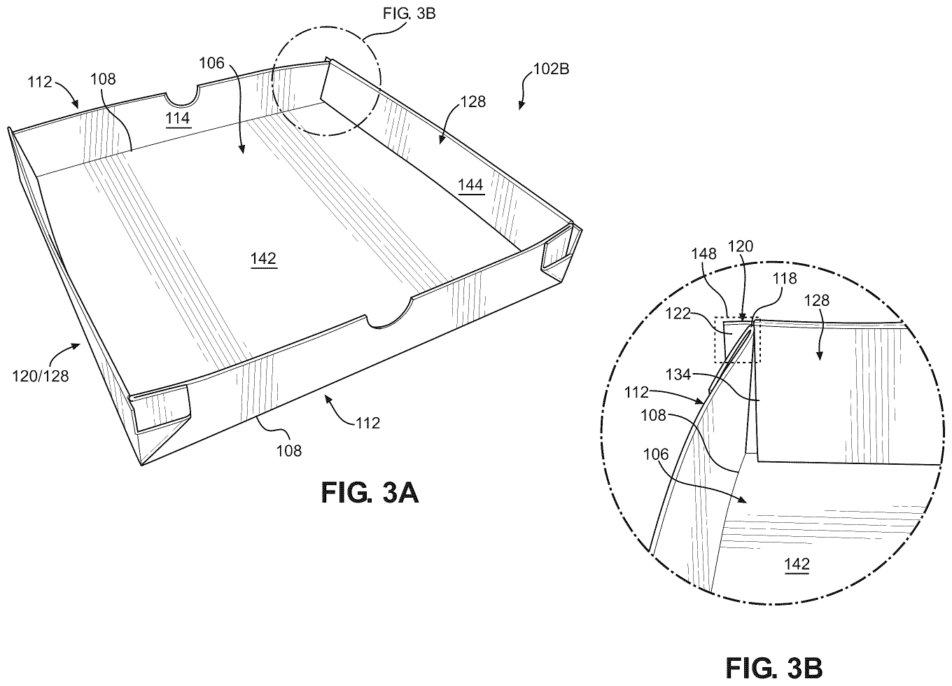

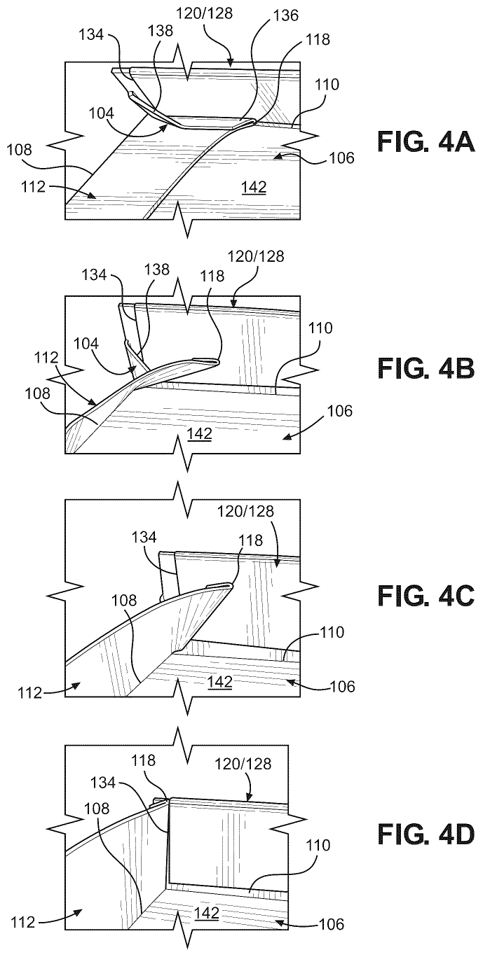

Referring now to the drawings in which like reference characters designate like or corresponding characters throughout the several views, there is shown FIG. 1 a single unassembled blank 100 that may be used for forming a food tray according to an embodiment of the present invention. With continued reference to FIG. 1 and with further reference to FIGS. 2A-2D and 3A, the blank 100A may be assembled to form a webbed-cornered self-erecting food tray 102 that may be selectively reconfigured between an assembled collapsed configuration 102A (FIG. 2D) and an assembled expanded configuration 102B (FIG. 3A). As shown in FIG. 3B, the food tray 102 includes a webbed corner 104 that selectively holds the tray in the assembled expanded configuration while allowing the tray to be quickly reconfigured to the assembled collapsed configuration. Finally, FIGS. 4A-4D illustrate a sequence for the movement of the webbed corner 104 that occurs while converting the tray from the assembled collapsed configuration to the assembled expanded configuration. Advantageously, as further discussed below and in contrast to conventional food trays, the webbed corner 104 is automatically engaged when the food tray is being reconfigured from the assembled collapsed configuration to the assembled expanded configuration. In particular, the webbed corner 104 is engaged without requiring handling by a user. This enables food trays according to the present invention to be more quickly formed and used than conventional designs.

Returning to FIG. 1, the blank 100 is formed by a base panel 106 having a pair of first opposing sides 108 and a pair of second opposing sides 110. The blank 100 also includes a pair of width panels 112. A separate width panel 112 is attached to the each of the first opposing sides 108 of the base panel 106. Each width panel 112 further includes an inner surface 114 and is defined by a first free edge 116 and a first connected edge that is formed at the first opposing side 108. A first foldable intersection is formed by the first connected edge 108 that is located between the base panel 106 and each width panel 112. In certain instances, this first foldable intersection may also be described as a “width joint.” Preferably, the width joint extends continuously along an entire width of the width panel 112. An opposing end 118 is located at each end of the width panels 112. Next, the blank 100 further includes a pair of length panels 120. A separate length panel 120 is attached to each of the second opposing sides 110 of the base panel 106. Each length panel 120 further includes an inner surface 122 and is defined by a second connected edge that is formed at the second opposing side 110 of the base panel 106 and an opposing third connected edge 124. A second foldable intersection is formed by the second connected edge 110 that is located between the base panel 106 and each length panel 122. In certain instances, this second foldable intersection may also be described as a “length joint.” Preferably, the length joint extends continuously along an entire length of the length panel 122. An opposing end 126 is located at each end of the length panels 122. Next, the blank 100 further includes a pair of lock panels 128. A separate lock panel 128 is joined to the length panel 120 preferably continuously along the third connected edge 124. Each lock panel 128 further includes an inner surface 130 and is defined by the third connected edge 124 and an opposing second free edge 132. Finally, an opposing end 134 is located at each end of the lock panels 128. Next, a webbed corner 104 is provided between each adjacent width panel 112 and length panel 120 of the blank 100. Each webbed corner 104 is formed by a fixed panel 136 and a movable panel 138. Preferably, the fixed panel 136 is hingedly joined to the width panel 112 along a first corner joint that is formed at the opposing end 118 of the width panel. Similarly, the movable panel 138 is hingedly joined to the length panel 120 along a second corner joint that is formed at the opposing end 126 of the length panel. In each webbed corner 104, the fixed panel 136 is hingedly joined together with the movable panel 138 along a third corner joint 140.

With continued reference to FIG. 1 and with further reference to FIGS. 2A-2D, the food tray 102A (FIG. 2D) in the assembled collapsed configuration is formed by folding the unassembled blank 100. In the assembled collapsed configuration, the food tray 102A is fully assembled but collapsed in a manner that makes it suitable for transport and storage. To form the tray 102A, the steps described below are carried out, preferably in the order described. First, as shown best in FIG. 2A, each lock panel 128 is folded inwards towards the base panel 106 along the third connected edge 124. Next, a center 152 of the inner surface 130 of each lock panel 128 is fixedly attached to a corresponding center 154 of the inner surface 122 of each length panel 120. For example, in certain preferred embodiments, the center 152 of the lock panel 128 is attached to the center 154 of the length panel 120 via an adhesive. However, other means for attaching the centers 152, 154 together may be used. On the other hand, the opposing ends 134 of the lock panel 128 are not attached to the length panel 120; instead, the opposing ends of the lock panel are configured to flare outwards away from the inner surface 122 of the length panel to provide flared ends. As further described below, the flared ends (i.e., opposing ends 134 of the lock panels 128), create locking mechanisms that contact the width panel 112 and, through such contact, prevent the width panels from folding inwards towards the base panel 106.

Next, as shown best in FIG. 2B, after the lock panels 128 are attached to the corresponding length panel 120, each width panel 112 is folded inwards toward the base panel 106 about the width joint (i.e., the first connected edge 108) and into contact with an outer surface 144 of the lock panel 128. At the same time, the webbed corner 104 is folded along a second corner joint that is formed at the opposing end 126 of the length panel. Next, as shown best in FIG. 2C and FIG. 2D, each combined lock panel 128 and length panel 120 is folded inwards toward the base panel 106 along the second connected edge 110 so that the outer surface 150 of each length panel 120 is visible. Simultaneously, the fixed panel 136 of each webbed corner 104 is folded along a first corner joint that is formed at the opposing end 118 of each width panel 112. The fixed panels 136 are then fixedly attached (e.g., adhered) to the outer surface 156 of the width panels. For example, in certain preferred embodiments, each fixed panel 136 is attached to the outer surface 156 of each width panel 112 via an adhesive.

When the tray 102 is in the assembled collapsed configuration, the width panels 112 and the combined length panel 120 and lock panel 128 are permitted to lay substantially flat against base panel 106. Put differently, in the assembled collapsed configuration, the inner surface 114 of each width panel 112 (see FIGS. 2A and 2B) is not oriented substantially perpendicularly to the inner surface 122 of each length panel 120 or the outer surface 150 (FIG. 2D) of each length panel 120. This is because the width panels 112 are able to freely fold inwards towards the base panel 106. Advantageously, when the tray 102 is in this configuration, the flattened position of the width panel 112 and the combined length panel 120 and lock panel 128 allows for trays to be stacked on top of one another and to be stored in greater numbers compared to the assembled expanded configuration (FIG. 3A).

As previously noted above, after assembly, the blank 100 (FIG. 1) is convertible between an assembled collapsed configuration (FIG. 2D) and an assembled expanded configuration (FIG. 3A). To convert the tray 102A from the assembled collapsed configuration shown in FIG. 2D to the assembled expanded configuration shown in FIG. 3A, the width panels 112 are simply folded outwards away from the base panel 106 about the first connected edge 108. When the tray 102 is in the assembled expanded configuration, the inner surface 114 of the width panel 112, the inner surface 122 of the length panel 120 (not shown in FIG. 3A but hidden behind lock panel 128), and the outer surface 144 of the lock panel 128 face inwards towards and are held substantially perpendicularly to the inner surface 142 of the base panel 106. Additionally, as shown best in FIG. 3B, each of the opposing ends 118 of each width panel 112 contacts one of the flared ends (i.e., opposing ends 134 of the lock panels 128) of one of the lock panels. Through such contact, the width panels 112 are prevented from folding inwards towards the inner surface 142 of the base panel 106 about the width joint (i.e., the first connected edge 108).

As shown best in FIG. 1, the distance between the opposing ends 134 of the lock panel 128 is less than the distance between the opposing ends 126 of the length panel 120 such that an engagement space 148 is provided adjacent to the inner surface 122 of the length panel and the opposing end of the lock panel. When the tray 102 is in the assembled expanded configuration, the opposing ends 118 of the width panel 112 are each located in an engagement space 148 when contacting the flared ends (i.e., opposing ends 134 of the lock panels 128) of the lock panel and are held substantially perpendicularly to the inner surface 142 of the base panel 106. More detailed views illustrating the procedure for automatically engaging the width panel 112 with the combined length panel 120 and lock panel 128 are provided in FIGS. 4A-4D. As shown, preferably, each width panel 112 is folded outward away from the base panel 106 about the width joint (i.e., the first connected edge 108). Since the width panels 112 and length panels 120 are connected together via webbed corners 104, raising the width panels in this manner causes the combined length panel 120 and lock panel 128 to also be automatically folded outwards away from the base panel 106 about the length joint (i.e., the second connected edge 110). Each width panel 112 is folded outwards until its opposing ends 118 passes the flared ends (i.e., opposing ends 134 of the lock panels 128). At that point, releasing the width panel 112 will cause it to fold inwards towards the base panel 106. However, as noted above, the width panel 112 contacts the lock panel 128 and is prevented from rotating further inwards. This is the assembled expanded configuration, which configuration is suitable for holding and transporting food items.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A tray formed from a single unassembled blank and, after being assembled, configured to be selectively reconfigured between an assembled collapsed configuration and an assembled expanded configuration and comprising:
a base panel having a pair of first opposing sides and a pair of second opposing sides;
a pair of width panels, each having an inner surface, an outer surface, a first free edge, a first connected edge, and a pair of opposing ends, wherein a separate one of each of the pair of width panels is joined continuously at the connected edge to one of the first opposing sides of the base along a width joint that extends continuously along an entire width of the width panel;
a pair of length panels, each having an inner surface, an outer surface, a second connected edge, a third connected edge, and a pair of opposing ends, wherein a separate one of each of the pair of length panels is joined continuously at the second connected edge to one of the second opposing sides of the base along a length joint that extends continuously along an entire length of the length panel;
a lock panel joined continuously along the third connected edge to each one of the pair of length panels, the lock panel having an inner surface, an outer surface, a second free edge, and a pair of opposing ends, wherein the lock panel is configured to be folded along the third connected edge and a center of the inner surface of the lock panel is configured to be fixedly attached to a center of the inner surface of the length panel and wherein the pair of opposing ends of the lock panel are not attached to the length panel and are configured to flare outwards from the length panel to provide flared ends;
a webbed corner disposed between each adjacent width and length panel, each webbed corner formed by:
a fixed panel hingedly joined to the width panel along a first corner joint and fixedly attached to the outer surface of the width panel; and
a movable panel hingedly joined to the length panel along a second corner joint, wherein the fixed panel and movable panel are joined together along a third corner joint;
wherein, when the tray is in the assembled collapsed configuration:
the inner surfaces of the width and length panels and the outer surface of the lock panels are not held substantially perpendicularly to an inner surface of the base panel;
the width panels are not prevented from folding inwards towards the base panel about the width joint by the lock panel;
wherein, when the tray is in the assembled expanded configuration:
the inner surfaces of the width and length panels and the outer surface of the lock panels are held substantially perpendicularly to the inner surface of the base panel;
each of the opposing ends of each width panel is configured to contact one of the flared end of one of said lock panels and, through such contact, to be prevented from folding inwards towards the base panel about the width joint.

2. The tray of claim 1 in wherein the center of each lock panel is fixedly attached to one of said centers of said length panels via an adhesive.

3. The tray of claim 1 wherein each fixed panel of each webbed corner is fixedly attached to the outer surface of one of said width panels via an adhesive.

4. The tray of claim 1 wherein:
when the tray is in the assembled collapsed configuration, the inner surfaces of the width panels are not oriented substantially perpendicularly to the inner surfaces of length panels and the outer surfaces of the lock panels; and
when the tray is in the assembled expanded configuration, the inner surfaces of the width panels are oriented substantially perpendicularly to the inner surfaces of length panels and the outer surfaces of the lock panels.

5. The tray of claim 1 wherein:
when the tray is in the assembled collapsed configuration, the fixed and movable panels of the webbed corners are not oriented perpendicularly to the inner surface of the length panels; and
when the tray is in the assembled expanded configuration, the fixed and movable panels of the webbed corners are oriented perpendicularly to the inner surface of the length panels.

6. The tray of claim 1 wherein a length measured between the opposing ends of the lock panel is less than a length measured between the opposing ends of the length panels such that a separate engagement space is provided adjacent the inner surface of the length panel and adjacent each opposing end of the lock panel,
wherein, in the assembled expanded configuration, the opposing ends of the width panels are each located in one of the engagement spaces when contacting the flared ends of the lock panel.

7. The tray of claim 6 wherein, when moving from the assembled collapsed configuration the assembled expanded configuration, opposing ends of the width panels are automatically positioned in the engagement space and contact the flared ends and are held substantially perpendicularly to the inner surface of the base panel.

8. A tray formed from a single unassembled blank and, after being assembled, configured to be selectively reconfigured between an assembled collapsed configuration and an assembled expanded configuration and comprising:
a base panel;
a pair of width panels hingedly joined to opposing sides of the base panel;
a pair of length panels hingedly joined to opposing sides of the base panel and adjacent each of the width panels; and
a webbed corner formed by a fixed panel and a movable panel and that is positioned between and connects each adjacent width and length panel; and
a lock panel hingedly joined to a free end of each length panel at a connected edge, wherein the lock panel is folded along the connected edge and a center of an inner surface of the lock panel is fixedly attached to a center of an inner surface of the length panel and wherein opposing ends of the lock panel are not attached to the length panel and flare outwards from the length panel to provide flared ends;
wherein, when the tray is in the assembled collapsed configuration:
the width and length panels are not held substantially perpendicularly to the base panel;
the width panels are not prevented from folding inwards towards the base panel by contacting the flared ends;
wherein, when the tray is in the assembled expanded configuration:
the width and length panels are held substantially perpendicularly to the base panel;
opposing ends of each width panel are configured to contact one of the flared ends of one of said lock panels and, through such contact, to be prevented from folding inwards towards the base panel about the width joint.

9. The tray of claim 8 in wherein the center of each lock panel is fixedly attached to one of said centers of said length panels via an adhesive.

10. The tray of claim 8 wherein each fixed panel of each webbed corner is fixedly attached to the outer surface of one of said width panels via an adhesive.

11. The tray of claim 8 wherein:
when the tray is in the assembled expanded configuration, the inner surfaces of the width panels are oriented substantially perpendicularly to the inner surfaces of length panels and the outer surfaces of the lock panels; and
when the tray is in the assembled collapsed configuration, the inner surfaces of the width panels are not oriented substantially perpendicularly to the inner surfaces of length panels and the outer surfaces of the lock panels.

12. The tray of claim 8 wherein:
When the tray is in the assembled collapsed configuration, the fixed and movable panels of the webbed corners are not oriented perpendicularly to the inner surface of the length panels; and
When the tray is in the assembled expanded configuration, the fixed and movable panels of the webbed corners are oriented perpendicularly to the inner surface of the length panels.

13. The tray of claim 8 wherein a length measured between the opposing ends of the lock panel is less than a length measured between the opposing ends of the length panels such that a separate engagement space is provided adjacent the inner surface of the length panel and adjacent each opposing end of the lock panel,
wherein, in the assembled expanded configuration, the opposing ends of the width panels are each located in one of the engagement spaces when contacting the flared ends of the lock panel.

14. The tray of claim 13 wherein, when moving from the assembled collapsed configuration to the assembled expanded configuration, opposing ends of the width panels are automatically positioned in the engagement space and contact the flared ends and are held substantially perpendicularly to the inner surface of the base panel.

15. A method of forming a tray comprising the steps of:
providing an unassembled, foldable blank comprising:
a base panel having a pair of first opposing sides and a pair of second opposing sides;
a pair of width panels, each having an inner surface, an outer surface, a first free edge, a first connected edge, and a pair of opposing ends, wherein a separate one of each of the pair of width panels is joined continuously at the connected edge to one of the first opposing sides of the base along a width joint that extends continuously along an entire width of the width panel;
a pair of length panels, each having an inner surface, an outer surface, a second connected edge, a third connected edge, and a pair of opposing ends, wherein a separate one of each of the pair of length panels is joined continuously at the second connected edge to one of the second opposing sides of the base along a length joint that extends continuously along an entire length of the length panel;
a lock panel joined continuously along the third connected edge to each one of the pair of length panels, the lock panel having an inner surface, an outer surface, a second free edge, and a pair of opposing ends; and
a webbed corner disposed between each adjacent width and length panel, each webbed corner formed by:
a fixed panel hingedly joined to the width panel along a first corner joint; and
a movable panel hingedly joined to the length panel along a second corner joint, wherein the fixed panel and movable panel are joined together along a third corner joint;
folding the blank into an assembled collapsed configuration by:
folding each lock panel inwards towards the base panel along the third connected edge and fixedly attaching a center of the inner surface of the lock panel to a center of the inner surface of the length panel to form a combined lock and length panel where the pair of opposing ends of each lock panel are not attached to the length panel and are configured to flare outwards from the length panel to provide flared ends;
folding each width panel inwards towards the base panel along the first connected edge;
folding each length panel inwards towards the base panel along the second connected edge;
fixedly attaching the fixed panel of each webbed corner to the outer surface of one of the width panels;
reconfiguring the blank into an assembled expanded configuration by:
folding each width panel outwards away from the base panel along the first connected
folding each combined lock and length panel outwards away from the base panel along the second connected edge;
contacting each opposing end of each width panel with one of the flared end of one of said lock panels and, through such contact, preventing the width panel from folding inwards towards the base panel about the first connected edge.

16. The method of claim 15 wherein the movable panels automatically fold inwards along the second corner joint as the width panels are folded inwards towards the base panel along the first connected edge.

17. The method of claim 15 wherein the fixed panels automatically fold inwards along the first corner joint as the length panels are folded inwards towards the base panel along the second connected edge.

18. The method of claim 15 wherein the opposing ends of each width panel automatically contact the flared end as the width panels are folded outwards from the base panel.

19. The method of claim 18 wherein the combined length and lock panels automatically fold outwards when the width panels are folded outwards.

20. The method of claim 15 wherein the flared ends flare outwards from the length panel automatically when the center of the inner surface of the lock panel is fixedly attached to the center of the inner surface of the length panel.
